(19) United States
(12) Patent Application Publication
(10) Pub. No.: US 2022/0193633 A1
(43) Pub. Date: Jun. 23, 2022

(54) USE OF POLYMERIC BEADS TO REMOVE OXIDATIVE COMPOUNDS FROM LIQUIDS

(71) Applicant: AUBURN UNIVERSITY, Auburn, AL (US)

(72) Inventors: Shelby D. WORLEY, Auburn, AL (US); Royall M. BROUGHTON, JR., Auburn, AL (US); Alicia M. TAYLOR, Auburn, AL (US)

(21) Appl. No.: 17/551,486

(22) Filed: Dec. 15, 2021

Related U.S. Application Data
(60) Provisional application No. 63/127,510, filed on Dec. 18, 2020.

(51) Int. Cl. B01J 20/26; B01J 20/28; A01N 43/50; A01P 1/00; C02F 1/28; C02F 1/00; C02F 1/44

(52) U.S. Cl. CPC B01J 20/267; B01J 20/261; B01J 20/262; B01J 20/28052; B01J 20/28016; C02F 2103/20; A01P 1/00; C02F 1/285; C02F 1/001; C02F 1/441; C02F 2307/04; A01N 43/50

(57) ABSTRACT

The present disclosure provides a means to remove oxidative compounds such as free halogen and chloramines from a liquid, while also providing components with antimicrobial properties in order to combat biofouling and the shedding of pathogens into liquids. In particular, methods of removing an oxidative compound from a liquid in which the liquid is contacted with one or more polymeric beads. As described herein, the oxidative compound binds to the polymeric bead and is removed from the liquid.

### CROSS REFERENCE TO RELATED APPLICATIONS

This application claims the benefit under 35 USC § 119(e) of U.S. Provisional Application Ser. No. 63/127,510, filed on Dec. 18, 2020, the entire disclosure of which is incorporated herein by reference.

### BACKGROUND

Water is essential for human life. Many different techniques for disinfection of water are utilized worldwide, including the use of halogens such as free chlorine, free bromine, and soluble chloramines to purify water. However, in certain applications, these materials must be effectively removed from water in order to achieve the desired use of the water. For example, in reverse osmosis water treatment units, the membrane employed can be damaged by free halogen residuals in the treatment water. Further, in medical water used in dialysate preparations for kidney treatment, the Food and Drug Administration in the United States requires that the concentration of free chlorine in the water transmitted to a patient must be below 0.1 ppm (mg/L). Moreover, for bottled water and water treated in pitchers containing filters, it is desirable to minimize the concentration of residual free chlorine because some consumers are allergic to chlorine residuals, even at very low levels. Also, some consumers object to a “chlorine taste” of water when free chlorine is present at levels greater than 0.3 ppm. Finally, it is essential to remove free chlorine and chloramines from water used in aquariums because free halogen compounds in aquarium water are known to kill fish.

Currently, the primary methods utilized to remove free halogens and chloramines from water include filtration of the water through beds or cartridges of activated carbon as well as irradiation with ultraviolet light. The carbon can be employed as a powder, in a granular form, or as a solid block. However, despite the usefulness of carbon filtration in adsorbing organic contaminants, free halogens, and chloramines, the carbon does not have antimicrobial properties. Chlorine, upon adsorption on activated carbon, is reduced to chloride (Cl—) which is not oxidative and thus cannot kill pathogenic microorganisms or inactivate virus particles. Accordingly, colonization of these pathogens within the carbon filtration material can result in biofouling. As a result, the biofouling affects flow rates and can also lead to undesirable shedding of the pathogens into the water, which is harmful for medical uses such as dialysis and for potable consumption. Therefore, a carbon filtration medium must be carefully monitored and replaced when contaminated, which is costly and time consuming. Removal of free halogens using ultraviolet light irradiation is an even more expensive alternative.

Thus, there exists a need for new compositions and methods for treating liquids such as water. Accordingly, the present disclosure provides a means to remove free halogens and chloramines from a liquid, while also providing an antimicrobial component to combat biofouling and the shedding of pathogens into the liquid.

The present disclosure provides a means to remove oxidative compounds such as free halogen and chloramines from a liquid, while also providing components with antimicrobial properties in order to combat biofouling and the shedding of pathogens into liquids. In particular, methods of removing an oxidative compound from a liquid in which the liquid is contacted with one or more polymeric beads are provided. As described herein, the oxidative compound binds to the polymeric bead and is removed from the liquid.

The polymeric beads of the present disclosure are not necessarily intended to replace activated carbon for several water treatment applications because carbon is typically necessary to adsorb undesirable organic compounds in the water. Instead, the polymeric beads of the present disclosure may be supplementary in nature to carbon for providing an antimicrobial component as well as a chlorine removal capabilities. In turn, it is contemplated that the lifetime usability of the activated carbon material would advantageously be extended.

### SUMMARY

The compositions and methods of the present disclosure provide several benefits compared to currently known techniques. In particular, many different applications of the compositions and methods could be realized in which oxidative compound removal from liquids with an accompanying antimicrobial component is desired.

In water treatment units utilizing reverse osmosis, beds or cartridge filters comprising the polymeric beads of the present disclosure could be added before those containing activated carbon. This technique would serve to minimize biofouling in the carbon and also provide additional adsorption sites for organic contaminants.

With continuing water flow, the polymeric beads of the present disclosure can become chlorinated by a reaction with free chlorine and chloramines, which would thus destroy undesirable contaminant pathogens in the water. Additional polymeric beads could be employed in the treatment unit when positioned after the carbon filters to rid the water of any remaining chlorine. This mechanism could protect the reverse osmosis membrane from degradation and would be particularly useful in a dialysis treatment purification unit since both chlorine and pathogens would be eliminated from the water received by the patient.

For treatment associated with point of use potable water, cartridge filters comprising the polymeric beads of the present disclosure could be used to remove chlorine and pathogens from both municipal water and well water sources. Commercial bottled water and water purification pitchers can also benefit from the polymeric beads of the present disclosure for both chlorine and pathogen removal. Likewise, water intended for use in aquariums can benefit from the polymeric beads of the present disclosure because fish are subject to death from minute amounts of free chlorine in the water. Problematic pathogens in aquarium water that adversely affect fish can also be reduced using the polymeric beads of the present disclosure.

Additional features of the present disclosure will become apparent to those skilled in the art upon consideration of illustrative embodiments exemplifying the best mode of carrying out the disclosure as presently perceived.

### DETAILED DESCRIPTION

In an illustrative aspect, a method of removing an oxidative compound from a liquid is provided. The method comprises the step of contacting the liquid with one or more polymers, wherein the oxidative compound binds to the polymer and is removed from the liquid.

In an embodiment, the oxidative compound is a halogen compound. In an embodiment, the halogen compound is free chlorine. As used herein, free chlorine refers to its generally understood meaning in the art, for instance hypochlorous acid, hypochlorite, and aqueous chlorine, the nature of which is dependent on pH.

In an embodiment, the halogen compound is free bromine. As used herein, free bromine refers to its generally understood meaning in the art, for instance hypobromous acid, hypobromite, and aqueous bromine, the nature of which is dependent on pH.

In an embodiment, the oxidative compound is a water-soluble chloramine. As used herein, a water-soluble chloramine refers to its generally understood meaning in the art, for instance organic compounds and inorganic derivatives of ammonia.

In an embodiment, the polymer comprises particles. In an embodiment, the polymer comprises beads. In an embodiment, the polymer is cross-linked. In an embodiment, the polymer is porous. In an embodiment, the polymer comprises particles. In an embodiment, the particles comprise beads. In an embodiment, the polymeric beads are cross-linked. In an embodiment, the particles are porous. In an embodiment, the porous polymeric particles are cross-linked. In an embodiment, the particles comprise porous beads. In an embodiment, the porous polymeric beads are cross-linked. In an embodiment, the polymeric bead comprises an N-halamine precursor.

Generally, the polymers of the present disclosure are precursors to halogenated molecules in a class known as organic N-halamines. N-halamine compounds are excellent for stabilizing halogens (e.g., oxidative Cl and Br) in covalent bonding and are thus used as antimicrobial materials for numerous applications. However, their use in water treatment has been limited. Importantly, although fully halogenated poly-styrene derivatives can be utilized in cartridge filters for disinfection of water, removing halogens from liquids has not been specifically attempted.

In an embodiment, the polymer comprises (poly-5-methyl-5-(4′-vinylphenyl)hydantoin), henceforth referred to as “PSH.” PSH is an un-halogenated precursor to a fully halogenated poly-styrene derivative. The fully halogenated poly-styrene derivative is described, for instance, in U.S. Pat. No. 6,548,054, which is incorporated herein in their entirety. The fully halogenated poly-styrene derivative kills bacteria and inactivates viruses following contact via a mechanism in which the halogen in a +1 oxidation state is directly transferred to the pathogenic cell, followed by inactivation by an oxidation process analogous to that by which free chlorine disinfects potable water in a municipal treatment plant.

The un-halogenated precursor PSH readily removes oxidative compounds (e.g., free chlorine, free bromine, and chloramines) from liquid upon contact, and then becomes increasingly antimicrobial as the concentration of the halogen on the polymer increases. In this process, the oxidative compounds in the liquid reacts with the nitrogen atoms on the hydantoin ring of the polymer to form strong N-halogen covalent chemical bonds in which the halogen carries a +1 oxidation state and is hence antimicrobial. This provides an advantage over chlorine removal by activated carbon because the carbon adsorbs the chlorine in a −1 oxidation state, which is not antimicrobial.

PSH is a repeating unit structure comprising

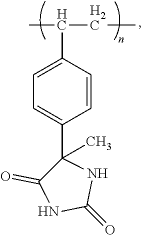

wherein X is independently H, Cl, or Br.

For instance, un-halogenated PSH beads can be prepared as described in U.S. Pat. No. 6,548,054. Porous, cross-linked poly-styrene beads, which can be obtained from sources such as Suqing Group (Jiangyin, Jiangsu, PRC) or Purolite Company (Philadelphia, Pa.) can employed. The poly-styrene beads should have particle sizes in the range between 250 to 600 μm in order to allow for adequate flow of liquid. The beads can be porous (e.g., pore sizes ranging from 30 to 70 nm) in order to provide sufficient surface area for uptake of oxidative compounds. The beads can be cross-linked (e.g., between 5 to 8 weight percent) to ensure hardness and lack of solubility in water and organic solvents. The poly-styrene beads are subjected to a Friedel Crafts reaction with acetyl chloride using anhydrous aluminum chloride as a catalyst in an appropriate organic solvent such as carbon disulfide or carbon tetrachloride. The resulting poly-4-vinylacetophenone porous bead product is then subjected to a Bucherer Bergs reaction using ammonium carbonate and potassium or sodium cyanide in an ethanol/water solvent under pressure to convert the ketone into a hydantoin ring and create the final polymeric beads comprising PSH.

In an embodiment, the polymer comprises a methylated poly-styrene, henceforth referred to as “MPSH.” MPSH is an un-halogenated precursor to a fully halogenated poly-styrene derivative. The fully halogenated poly-styrene derivative is described, for instance, in U.S. Pat. No. 7,687,072, Chen, et al., J. Appl. Polym. Sci., 2004, 92, 368, and Aviv, et al., Biomacromolecules, 2015, 16, 1442, all of which are incorporated herein in their entirety. The fully halogenated poly-styrene derivative kills bacteria and inactivates viruses in a similar manner as described previously, similarly to PSH, for example in a filter application. Generally, MPSH is less expensive to produce than PSH.

Similar to PSH, the un-halogenated precursor MPSH readily removes oxidative compounds from liquid upon contact, and then becomes increasingly antimicrobial as the concentration of the halogen on the polymer increases. Generally, MPSH is less expensive to produce than PSH.

MPSH is a repeating unit structure comprising

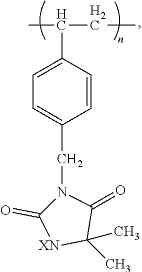

wherein X is independently H, Cl, or Br.

For instance, un-halogenated MPSH beads can be prepared as described in U.S. Pat. No. 7,687,072. The starting material is chloromethylated poly-styrene beads comprising similar particle sizes, pore sizes, and weight percent cross-linking as used for the poly-styrene starting material for PSH beads. The same material (Merrifield resin) is commonly employed in the syntheses of peptides and small proteins. The chloromethylated poly-styrene beads are reacted in a simple S_{N}2 process with the sodium or potassium salt of 5,5-dimethylhydantoin in an organic solvent such as anhydrous dimethyl formamide (DMF) to produce the final MPSH porous bead product. This procedure is somewhat simplified and less expensive compared to the one used for PSH beads because the 5,5-dimethylhydantoin, which is produced industrially from ammonium carbonate and sodium or potassium cyanide, can be sourced commercially without the need for cyanide handling.

In an embodiment, the polymer comprises “NOM,” which is a meta-aramid polymer bead prepared from commercial fiber NOMEX™. Generally, NOM is described, for instance, in U.S. Pat. No. 8,535,654, which is incorporated herein in its entirety. NOM will also remove oxidative compounds (e.g., free chlorine, free bromine, and chloramines) from liquid upon contact and also become antimicrobial. Generally, polymers comprising NOM are less expensive to produce than polymers comprising PSH or MPSH.

NOM is a repeating unit structure comprising

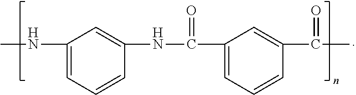

For instance, un-halogenated NOM beads can be prepared as described in U.S. Pat. No. 8,535,654. The fiber NOMEX™, which can be purchased from DuPont, Inc., is dissolved in an ionic solvent such as 1-butyl-3-methylimidazolium chloride or an organic solvent such as DMF. The solution is then precipitated in excess ethanol or water to produce a bead product with bead size 0.5 to 10 μm.

In an embodiment, the liquid comprises water. In an embodiment, the liquid consists essentially of water. In an embodiment, the liquid consists of water.

In an embodiment, the liquid comprises water selected from the group consisting of water for kidney dialysis, water for potable water, water for bottled water, water for a water treatment pitcher, and water for an aquarium. In an embodiment, the liquid comprises water for kidney dialysis. In an embodiment, the liquid comprises water for potable water. In an embodiment, the liquid comprises water for bottled water. In an embodiment, the liquid comprises water for a water treatment pitcher. In an embodiment, the liquid comprises water for an aquarium.

In an embodiment, the binding of the oxidative compound to the polymer is covalent binding. In an embodiment, the method is configured for use in a vessel. In an embodiment, the method is configured for use in a filter cartridge. In an embodiment, the method is configured for use in a resin treatment bed. In an embodiment, the method is configured for use in a water treatment unit comprising a reverse osmosis membrane.

In an embodiment, the method is configured for removing the oxidative compound from stationary water. In an embodiment, the method is configured for removing the oxidative compound from gravity fed water. In an embodiment, the method is configured for removing the oxidative compound from standing water. In an embodiment, the method is configured for removing the oxidative compound from pumped water. In an embodiment, the method is configured for removing the oxidative compound from re-circulated water.

In an embodiment, the method provides one or more antimicrobial polymers. In an embodiment, the antimicrobial polymer comprises Cl. In an embodiment, the Cl is covalently bound to the antimicrobial polymer. In an embodiment, the antimicrobial polymer comprises Br. In an embodiment, the Br is covalently bound to the antimicrobial polymer.

Without being bound by any theory, it is contemplated that the polymers become increasingly antimicrobial as the “X” units on the described structures are converted from H to Cl or Br through chemical reactions. Thus, with an increasing number of Cl and/or Br substituted for “X” on the repeating unit structures of the polymers of the present disclosure, the resultant polymers become increasingly more antimicrobial.

In an illustrative aspect, an antimicrobial composition is provided. The antimicrobial composition one or more polymers produced by any of the methods described herein. In an embodiment, the antimicrobial composition comprises Cl. In an embodiment, the Cl is covalently bound to the antimicrobial polymer. In an embodiment, the antimicrobial composition comprises Br. In an embodiment, the Br is covalently bound to the antimicrobial polymer.

In an embodiment, the polymer comprises particles. In an embodiment, the particles comprise beads. In an embodiment, the polymeric beads are cross-linked. In an embodiment, the particles are porous. In an embodiment, the porous polymeric particles are cross-linked. In an embodiment, the particles comprise porous beads. In an embodiment, the porous polymeric beads are cross-linked. In an embodiment, the polymer comprises an N-halamine precursor.

The previously described embodiments of the method of removing an oxidative compound from a liquid are also applicable to the antimicrobial compositions described herein.

The following numbered embodiments are contemplated and are non-limiting:

1. A method of removing an oxidative compound from a liquid, said method comprising the step of contacting the liquid with one or more polymers, wherein the oxidative compound binds to the polymer and is removed from the liquid.

2. The method of clause 1, any other suitable clause, or any combination of suitable clauses, wherein the oxidative compound is a halogen compound.

3. The method of clause 2, any other suitable clause, or any combination of suitable clauses, wherein the halogen compound is free chlorine.

4. The method of clause 2, any other suitable clause, or any combination of suitable clauses, wherein the halogen compound is free bromine.

5. The method of clause 1, any other suitable clause, or any combination of suitable clauses, wherein the oxidative compound is a water-soluble chloramine.

6. The method of clause 1, any other suitable clause, or any combination of suitable clauses, wherein the polymer comprises particles.

7. The method of clause 1, any other suitable clause, or any combination of suitable clauses, wherein the polymer comprises beads.

8. The method of clause 1, any other suitable clause, or any combination of suitable clauses, wherein the polymer is cross-linked.

9. The method of clause 1, any other suitable clause, or any combination of suitable clauses, wherein the polymer is porous.

10. The method of clause 9, any other suitable clause, or any combination of suitable clauses, wherein the porous polymer is cross-linked.

11. The method of clause 6, any other suitable clause, or any combination of suitable clauses, wherein the particles comprise porous beads.

12. The method of clause 11, any other suitable clause, or any combination of suitable clauses, wherein the porous polymeric beads are cross-linked.

13. The method of clause 1, any other suitable clause, or any combination of suitable clauses, wherein the polymer comprises an N-halamine precursor.

14. The method of clause 1, any other suitable clause, or any combination of suitable clauses, wherein the polymer comprises PSH, wherein PSH is a repeating unit structure comprising

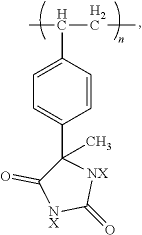

wherein X is independently H, Cl, or Br.

15. The method of clause 1, any other suitable clause, or any combination of suitable clauses, wherein the polymer comprises MPSH, wherein MPSH is a repeating unit structure comprising

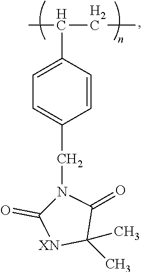

wherein X is independently H, Cl, or Br.

16. The method of clause 1, any other suitable clause, or any combination of suitable clauses, wherein the polymer comprises NOM, wherein NOM is a repeating unit structure comprising

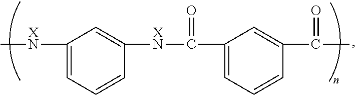

wherein X is independently H, Cl, or Br.

17. The method of clause 1, any other suitable clause, or any combination of suitable clauses, wherein the liquid comprises water.

18. The method of clause 1, any other suitable clause, or any combination of suitable clauses, wherein the liquid consists essentially of water.

19. The method of clause 1, any other suitable clause, or any combination of suitable clauses, wherein the liquid consists of water.

20. The method of clause 1, any other suitable clause, or any combination of suitable clauses, wherein the liquid comprises water selected from the group consisting of water for kidney dialysis, water for potable water, water for bottled water, water for a water treatment pitcher, and water for an aquarium.

21. The method of clause 1, any other suitable clause, or any combination of suitable clauses, wherein the liquid comprises water for kidney dialysis.

22. The method of clause 1, any other suitable clause, or any combination of suitable clauses, wherein the liquid comprises water for potable water.

23. The method of clause 1, any other suitable clause, or any combination of suitable clauses, wherein the liquid comprises water for bottled water.

24. The method of clause 1, any other suitable clause, or any combination of suitable clauses, wherein the liquid comprises water for a water treatment pitcher.

25. The method of clause 1, any other suitable clause, or any combination of suitable clauses, wherein the liquid comprises water for an aquarium.

26. The method of clause 1, any other suitable clause, or any combination of suitable clauses, wherein the binding of the oxidative compound to the polymer is covalent binding.

27. The method of clause 1, any other suitable clause, or any combination of suitable clauses, wherein the method is configured for use in a vessel.

28. The method of clause 1, any other suitable clause, or any combination of suitable clauses, wherein the method is configured for use in a filter cartridge.

29. The method of clause 1, any other suitable clause, or any combination of suitable clauses, wherein the method is configured for use in a resin treatment bed.

30. The method of clause 1, any other suitable clause, or any combination of suitable clauses, wherein the method is configured for use in a water treatment unit comprising a reverse osmosis membrane.

31. The method of clause 1, any other suitable clause, or any combination of suitable clauses, wherein the method is configured for removing the oxidative compound from stationary water.

32. The method of clause 1, any other suitable clause, or any combination of suitable clauses, wherein the method is configured for removing the oxidative compound from gravity fed water.

33. The method of clause 1, any other suitable clause, or any combination of suitable clauses, wherein the method is configured for removing the oxidative compound from standing water and/or from pumped water.

34. The method of clause 1, any other suitable clause, or any combination of suitable clauses, wherein the method is configured for removing the oxidative compound from re-circulated water.

35. The method of clause 1, any other suitable clause, or any combination of suitable clauses, wherein the method provides one or more antimicrobial polymers.

36. The method of clause 35, any other suitable clause, or any combination of suitable clauses, wherein the antimicrobial polymer comprises Cl.

37. The method of clause 36, any other suitable clause, or any combination of suitable clauses, wherein the antimicrobial polymer comprises Cl that is covalently bound to the polymer.

38. The method of clause 35, any other suitable clause, or any combination of suitable clauses, wherein the antimicrobial polymer comprises Br.

39. The method of clause 38, any other suitable clause, or any combination of suitable clauses, wherein the antimicrobial polymer comprises Br that is covalently bound to the polymer.

40. An antimicrobial composition comprising one or more polymers produced by the method of clause 1.

41. The antimicrobial composition of clause 40, any other suitable clause, or any combination of suitable clauses, wherein the composition comprises Cl.

42. The antimicrobial composition of clause 41, any other suitable clause, or any combination of suitable clauses, wherein the Cl is covalently bound to the polymer.

43. The antimicrobial composition of clause 40, any other suitable clause, or any combination of suitable clauses, wherein the composition comprises Br.

44. The antimicrobial composition of clause 43, any other suitable clause, or any combination of suitable clauses, wherein the Br is covalently bound to the polymer.

45. The antimicrobial composition of clause 40, any other suitable clause, or any combination of suitable clauses, wherein the polymer comprises particles.

46. The antimicrobial composition of clause 45, any other suitable clause, or any combination of suitable clauses, wherein the particles comprise beads.

47. The antimicrobial composition of clause 46, any other suitable clause, or any combination of suitable clauses, wherein the polymeric beads are cross-linked.

48. The antimicrobial composition of clause 45, any other suitable clause, or any combination of suitable clauses, wherein the particles are porous.

49. The antimicrobial composition of clause 48, any other suitable clause, or any combination of suitable clauses, wherein the porous polymeric particles are cross-linked.

50. The antimicrobial composition of clause 45, any other suitable clause, or any combination of suitable clauses, wherein the particles comprise porous beads.

51. The antimicrobial composition of clause 50, any other suitable clause, or any combination of suitable clauses, wherein the porous polymeric beads are cross-linked.

52. The antimicrobial composition of clause 40, any other suitable clause, or any combination of suitable clauses, wherein the polymer comprises an N-halamine precursor.

53. The antimicrobial composition of clause 40, any other suitable clause, or any combination of suitable clauses, wherein the polymer comprises PSH, wherein PSH is a repeating unit structure comprising

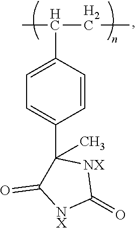

wherein X is independently H, Cl, or Br.

54. The antimicrobial composition of clause 40, any other suitable clause, or any combination of suitable clauses, wherein the polymer comprises MPSH, wherein MPSH is a repeating unit structure comprising

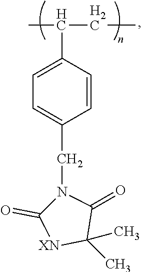

wherein X is independently H, Cl, or Br.

55. The antimicrobial composition of clause 40, any other suitable clause, or any combination of suitable clauses, wherein the polymer comprises NOM, wherein NOM is a repeating unit structure comprising

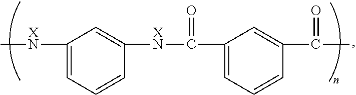

wherein X is independently H, Cl, or Br.

The present invention is more particularly described in the following examples which are intended as illustrative only since numerous modifications and variations therein will be apparent to those skilled in the art.

### EXAMPLES

### Example 1

### Analytical Methods to Evaluate Oxidative Compounds

Several analytical methods can be utilized to evaluate the presence and concentrations of oxidative compounds in liquids. For instance, concentrations of oxidative compounds such as of free chlorine, free bromine, and chloramines in water can be measured using several analytical methods.

A common method to evaluate oxidative compounds in liquid is iodometric/thiosulfate titration. For example, water containing a halogen compound can be treated with potassium iodide, dilute acetic acid, and starch solution causing a reaction of the potassium iodide (KI) with the oxidative halogen compound to produce iodine, which in the presence of the starch provides a dark blue color to the solution. The solution is then titrated with dilute sodium thiosulfate until the color disappears at the end point. The volume of the solution and the volume of the titrant at the end point can then be used to calculate the concentration of the oxidant in the sample. The detection limits for chlorine and bromine using this method have been tested to be 0.27 ppm and 0.60 ppm for Cl⁺ and Br⁺, respectively.

A second method utilized for determination of free chlorine concentration is a colorimetric method. In this method, a solution is allowed to react in a phosphate buffer solution with KI, the indicator N,N-diethyl-p-phenylene-diamine (DPD) producing a pink color which can be detected with a spectrophotometer set at 528 nm. Calibration with solutions having different known chlorine concentrations then allows determination of the unknown free chlorine concentration. The stated detection limit for chlorine as Cl⁺ by this method is 0.01 ppm. For the colorimetric method, total chlorine concentrations (the combination of free chlorine and combined chlorine) can be determined as well as the free chlorine concentrations. A suitable spectrophotometer and reagents for free and total chlorine determination can be purchased from Hach, Inc. (Loveland, Colo., USA).

A third method is potentiometric titration. The detection limit for free Cl⁺ using this method is as low as 0.0015 ppm, and it may be more accurate than the colorimetric method at low concentrations of free chlorine.

### Example 2

### Measured Maximum Uptake of Free Halogens by PSH Polymeric Beads

In the instant example, PSH polymeric beads were used as the exemplary polymeric beads. Free chlorine and free bromine were used as the exemplary oxidative compounds to be removed from water.

Un-halogenated PSH polymeric beads were suspended in aqueous 1 N NaOH and chlorine gas was added at 10° C. until the solution became saturated with free chlorine. After 1.5 hours of stirring at 25° C., the polymeric beads were removed from the solution, washed with water, and dried in air.

Iodometric/thiosulfate titration indicated that the dry polymeric beads contained 20.0 weight percent Cl⁺. The theoretical value based upon a repeating unit of the structure is 24.9 weight percent Cl⁺. The measured lower concentration is indicative of the 5.6 weight percent cross-linking in the poly-styrene used to prepare the PSH, the cross-linking agent being divinyl benzene.

Un-halogenated PSH polymeric beads were suspended in aqueous 2 N NaOH and liquid bromine was added dropwise at 25° C. over a period of 10 minutes. The pH was adjusted to 6.4 by addition of 4 N acetic acid, and the mixture was stirred at 25° C. for 1 hour. The polymeric beads were removed from the solution, washed with water, and dried in air.

Iodometric/thiosulfate titration indicated that the dry polymeric beads contained 36.8 weight percent Br⁺. The theoretical value based upon a repeating unit of the structure is 42.8 weight percent Br⁺. Again, the lower measured value was due primarily to the 5.6 weight percent cross-linking in the poly-styrene used to prepare the PSH. The results in this example indicate that the PSH polymeric beads uptake free chlorine and free bromine from aqueous solution very efficiently.

### Example 3

### Measured Maximum Uptake of Free Halogens by MPSH Polymeric Beads

In the instant example, MPSH polymeric beads were used as the exemplary polymeric beads. Free chlorine and free bromine were used as the exemplary oxidative compounds to be removed from water.

Un-halogenated MPSH polymeric beads were suspended in an aqueous solution of 5.25% sodium hypochlorite. The pH was adjusted to 7.5 using 2 N acetic acid and the mixture was stirred for 45 minutes at 25° C. After rinsing and drying under vacuum at 50° C. until constant weight, the polymeric beads were subjected to iodometric/thiosulfate titration. The Cl+ loading was 6.3 weight percent.

The theoretical Cl+ for an MPSH repeating unit is 12.7 weight percent. Again, the lowered measured Cl+ loading can be attributed to 5.6 weight percent cross-linking in the sourced chloromethylated polystyrene which was used to prepare the MPSH beads.

Un-halogenated MPSH polymeric beads were suspended in an aqueous solution of 10% sodium hypobromite, and the pH was adjusted to 7.0 using 2 N acetic acid. The mixture was stirred for 1 hour at 25° C., rinsed with water, dried to constant weight under vacuum, and subjected to iodometric/thiosulfate titration.

The Br+ loading was 8.2 weight percent (theoretical based upon a repeating unit of MPSH is 24.8 weight percent). The results in this example indicate that the porous polymeric MPSH beads uptake free chlorine and free bromine.

### Example 4

### Measured Maximum Uptake of Free Halogens by NOM Polymeric Beads

In the instant example, NOM polymeric beads were used as the exemplary polymeric beads. Free chlorine and free bromine were used as the exemplary oxidative compounds to be removed from water.

For chlorination, un-halogenated NOM polymeric beads were placed in a diluted (9:1) household bleach solution. The pH was adjusted to 7.0 using 6 N HCl. After 1 hour at 25° C. with stirring, the polymeric beads were collected on filter paper, rinsed with water, and dried at 45° C. for 1 hour. Iodometric/thiosulfate titration indicated a chlorine loading of 6.72 weight percent Cl⁺. The theoretical value for a repeating unit of the polymer is 23.1 weight percent.

Bromination of the un-halogenated NOM polymeric beads used bromine liquid at pH 7.0 (adjusted with 4 N acetic acid) for 1 hour exposure at 25° C., and then rinsing and drying for 1 hour at 45° C., resulted in a titrated value of 4.09 weight percent Br⁺. The theoretical value for a repeating unit of the polymer is 40.4 weight percent. The results in this example indicate that NOM polymeric beads uptake free chlorine and free bromine.

### Example 5

### Stationary Dechlorination Test

A 2.0 ppm solution of free chlorine as Cl⁺ was prepared from aqueous sodium hypochlorite. Three Erlenmeyer flasks (designated PSH 1, PSH 2, PSH 3) were employed, each containing 1.0 gram of PSH polymeric beads. A 100 mL portion of the 2.0 ppm Cl solution was added to each flask containing the PSH polymeric beads. After the addition of the free chlorine solution, each flask was swirled for 30 seconds, and swirled again approximately every 5 minutes for 15 seconds throughout the experiment. In triplicate, 5 mL aliquots of solution were removed from the flasks at 5 minute time intervals. These intervals were split among the three flasks in order to keep the amount of solution in each flask above 70% of the original volume, as shown below. Therefore, for each flask, there was a 15 minute time frame between aliquot collections.

Aliquots were removed at the following time points for the PSH 1, PSH 2, and PSH 3 polymeric beads: i) PSH 1: removed at 5, 20, and 35 minutes; ii) PSH 2: removed at 10, 25, and 40 minutes; and iii) PSH 3: removed at 15, 30, and 45 minutes.

In triplicate, 5 mL aliquots of solution were taken from the flasks of free chlorine solution and PSH polymeric beads at each given time interval and placed in 50 mL of distilled water in an Erlenmeyer flask. This was followed by the addition of 0.1 g potassium iodide, 15 drops of 4 N acetic acid, and 15 drops of 0.5% starch solution. The resulting solutions were swirled, and the presence of chlorine in solution was observed by a change in color from clear to light blue. The resulting solutions were titrated with 0.0015 N sodium thiosulfate using a burette with 0.05 mL increments. The results shown in Table 1 demonstrate that 1 g of PSH polymeric beads in a flask in contact with 2.0 ppm aqueous free chlorine can remove at least 86.5% of the chlorine from the water within 20 minutes. The lower detection limit of the iodometric/thiosulfate analytical procedure was 0.27 ppm.

TABLE 1

| PSH Polymeric | | Average Free |
|---|---|---|
| Bead Flask | Contact Time | Chlorine Present |
| Number | (min) | As Cl⁺ (ppm) |
| All | 0 | 2.00 |
| PSH 1 | 5 | 1.11 |
| PSH 2 | 10 | 0.842 |
| PSH 3 | 15 | 0.487 |
| PSH 1 | 20 | <0.27 |
| PSH 2 | 25 | <0.27 |
| PSH 3 | 30 | <0.27 |
| PSH 1 | 35 | <0.27 |
| PSH 2 | 40 | <0.27 |
| PSH 3 | 45 | <0.27 |

Without being bound by any theory, results of the instant example show that free chlorine can be removed from standing water periodically swirled in a vessel by 1 g of PSH polymeric beads in a contact time of between 15 and 20 minutes.

### Example 6

### Gravity Flow Dechlorination Test

A 50 mL burette was plugged with glass wool by using a glass rod to compact the wool to the 50 mL mark. Weighed PSH polymeric beads were then added into the burette and distilled water was used to rinse any polymeric beads down the column to form a layer above the glass wool. Additional distilled water was added, and a glass rod was used to compact the PSH polymeric beads. After the polymeric beads had settled, the distilled water was allowed to flow through the burette until the meniscus line of the distilled water touched the top of the polymeric beads, and a graduated cylinder was placed under the burette. The remaining solution was then allowed to drain into the graduated cylinder to obtain a measure of the empty bed volume. To capture all liquid, air was blown into the burette to obtain the most accurate empty bed volume.

After obtaining the empty bed volume, a 1.9 ppm Cl+ was added to the burette and allowed to flow freely through the column by gravity feed (fully open stopcock). A time measurement was performed as the solution made contact with the PSH polymeric beads. A 100 mL portion of solution was added into the burette as it drained to keep the flow rate as constant as possible. After the solution completed flowing consistently, the time was recorded such that the flow rate could be calculated. The contact time was determined as the quotient of the empty bed volume divided by the flow rate. In triplicate, 5 mL aliquots of solution were taken from the resulting effluent of free chlorine solution and placed in 50 mL of distilled water in Erlenmeyer flasks. The solutions were titrated by the method described in Example 5. The results in Table 2 were obtained.

TABLE 2

| | Test 1 | Test 2 |
|---|---|---|
| PSH Weight (g) | 1.0 | 1.5 |
| Influx Cl⁺ Concentration (ppm) | 1.9 | 1.9 |
| Effluent Cl⁺ Concentration (ppm) | <0.27 | <0.27 |
| % Decrease in Cl⁺ Concentration | >85.8 | >85.8 |
| Empty Bed Volume (mL) | 2.00 | 3.25 |
| Total Flow Time (sec) | 338 | 306 |
| Flow Rate (mL/sec) | 0.300 | 0.327 |
| Bed Contact Time (sec) | 6.67 | 9.94 |

Without being bound by any theory, results of the instant example show that both 1.0 g and 1.5 g of the PSH polymeric beads could remove the 1.9 ppm of free chlorine from gravity-fed water to a concentration lower than the detection limit of iodometric/thiosulfate analytical titration.

### Example 7

### Pumped Flow Dechlorination Test

A 50 mL burette was plugged with glass wool by using a glass rod to compact the wool to the 50 mL mark. PSH polymeric beads were then added into the burette and distilled water was used to rinse any beads down the column to form a layer above the glass wool. Additional distilled water was added, and a glass rod was used to compact the PSH polymeric beads. After the polymeric beads had settled, the distilled water was allowed to flow through the burette until the meniscus line of the distilled water touched the top of the polymeric beads, and a graduated cylinder was placed under the burette. The remaining solution was then allowed to drain into the graduated cylinder to obtain a measure of the empty bed volume.

To capture all liquid, air was blown into the burette to obtain the most accurate empty bed volume. The effluent tubing of a peristaltic pump was inserted through a rubber stopper, which was then attached to the top of the burette and sealed with parafilm.

A beaker was filled with 1.53 ppm free chlorine solution, and the influx tube to the pump was placed in the solution. The pump was activated, and a timer was begun when the solution made contact with the PSH polymeric beads. The pump was stopped when solution no longer flowed through the burette tip consistently. In triplicate, 5 mL aliquots of effluent free chlorine solution were removed and titrated as in Examples 5 and 6. The results in Table 3 were obtained.

TABLE 3

| | Test 1 | Test 2 | Test 3 |
|---|---|---|---|
| PSH Weight (g) | 1.0 | 1.5 | 2.0 |
| Influx Cl⁺ Concentration (ppm) | 1.53 | 1.53 | 1.53 |
| Effluent Cl⁺ Concentration (ppm) | 0.71 | <0.27 | <0.27 |
| % Decrease in Cl⁺ Concentration | 53.6 | >82.4 | >82.4 |
| Empty Bed Volume (mL) | 2.2 | 2.5 | 2.8 |
| Total Flow Time (sec) | 118 | 115 | 111 |
| Flow Rate (mL/sec) | 0.85 | 0.87 | 0.89 |
| Bed Contact Time (sec) | 2.60 | 2.88 | 3.13 |

Without being bound by any theory, results of the instant example show that between 1.0 g and 1.5 g of the PSH polymeric beads could remove the 1.53 ppm of free chlorine from pumped water to a concentration lower than the detection limit of our iodometric/thiosulfate analytical titration (0.27 ppm) in less than 3 seconds of bed contact. Results also suggest that the removal of free chlorine can be enhanced by lengthening the contact time in the polymeric bead bed.

### Example 8

### Recirculated Flow Free Chlorine Test

Similar to Example 7, a beaker was filled with 1.26 ppm free chlorine solution, and the influx tube of a peristaltic pump was placed in the solution. The pump was activated, and a timer was begun when the solution made contact with the PSH polymeric beads. The pump was stopped when 100 mL of solution had flowed through the burette tip. In triplicate, 5 mL aliquots of solution were removed from the resulting effluent of free chlorine solution to be titrated as in Example 7. The remaining 85 mL of effluent solution was then placed in the influx beaker to rerun through the burette. The pump was activated and a timer was started when the solution made contact with the PSH polymeric beads. Triplicate 5 mL aliquots of this re-circulated effluent were also titrated. The results are shown in Table 4.

TABLE 4

| | Cycle 1 | Cycle 2 |
|---|---|---|
| PSH Weight (g) | 1.0 | 1.0 |
| Volume Free Chlorine (mL) | 100 | 85 |
| Influx Cl⁺ Concentration (ppm) | 1.26 | 0.532 |
| Effluent Cl⁺ Concentration (ppm) | 0.532 | <0.27 |
| % Decrease in Cl⁺ Concentration | 57.8 | >78.6 |
| Empty Bed Volume (mL) | 2.2 | 2.2 |
| Total Flow Time (sec) | 107 | 196 |
| Flow Rate (mL/sec) | 0.93 | 0.94 |
| Total Bed Contact Time (sec) | 2.37 | 4.71 |

Without being bound by any theory, results of the instant example show that 1.0 g of the PSH polymeric beads could remove the 1.26 ppm of free chlorine from pumped water to a concentration lower than the detection limit of iodometric/thiosulfate analytical titration (0.27 ppm) when the solution was circulated through the bead bed twice.

### Example 9

### Recirculated Flow Free Bromine Test

Similar to Example 8, a solution containing 100 mL of 6.0 ppm free bromine was pumped through a burette containing 1.0 g of PSH polymeric beads. In triplicate, 5.0 mL aliquots of effluent solution were removed for titration. The remaining 85 mL of effluent free bromine solution were then placed in the influx beaker to rerun through the burette. Following this procedure, a second set of triplicate 5.0 mL aliquots were removed for titration. A third and final cycling of the remaining 70 mL of effluent free bromine solution was performed with subsequent removal of an additional set of triplicate 5.0 mL aliquots for titration. The following results in Table 5 were obtained.

TABLE 5

| | Cycle 1 | Cycle 2 | Cycle 3 |
|---|---|---|---|
| PSH Weight (g) | 1.0 | 1.0 | 1.0 |
| Volume Br⁺ Solution (mL) | 100 | 85 | 70 |
| Influx Br⁺ Concentration (ppm) | 6.00 | 1.90 | <0.60 |
| Effluent Br⁺ Concentration (ppm) | 1.90 | <0.60 | <0.60 |
| % Decrease in Br⁺ Concentration | 68.3 | >68.3 | >68.3 |
| Empty Bed Volume (mL) | 2.2 | 2.2 | 2.2 |
| Total Flow Time (sec) | 135 | 244 | 337 |
| Flow Rate (mL/sec) | 0.74 | 0.78 | 0.75 |
| Total Bed Contact Time (sec) | 3.0 | 5.8 | 8.7 |

Without being bound by any theory, results of the instant example show that 1.0 g of PSH polymeric beads could remove 6.0 ppm of free bromine from pumped water to a concentration lower than the detection limit of iodometric/thiosulfate analytical titration (0.60 ppm) when the solution was circulated through the bead bed at least twice

### Example 10

### Recirculated Flow Chloramine Test

Similar to Examples 7-9, a solution containing the organic N-chloramine trichloroisocyanuric acid (TCCA), titrated as 1.60 ppm total Cl+, was circulated twice through the burette containing 1.0 g of PSH polymeric beads. Total chlorine is a combination of free and combined chlorine that can be analytically determined by the iodometric/thiosulfate titration method. Triplicate aliquots containing 5.0 mL each of the effluent solution were removed for titration after each cycle. The first solution cycle contained 100 mL and the second solution cycle contained the remaining 85 mL. The results are shown in Table 6.

TABLE 6

| | Cycle 1 | Cycle 2 |
|---|---|---|
| PSH Weight (g) | 1.0 | 1.0 |
| Volume TCCA Solution (mL) | 100 | 85 |
| Influx TCCA Total Cl⁺ Concentration (ppm) | 1.60 | 1.10 |
| Effluent TCCA Total Cl⁺ Concentration (ppm) | 1.10 | ≤0.27 |
| % Decrease in TCCA Total Cl⁺ Concentration | 31.2 | ≥75.5 |
| Empty Bed Volume | 2.2 | 2.2 |
| Total Flow Time (sec) | 159 | 307 |
| Flow Rate (mL/sec) | 0.63 | 0.58 |
| Total Bed Contact Time (sec) | 3.5 | 7.3 |

Without being bound by any theory, results of the instant example show that 1.0 g of PSH polymeric beads could remove 1.60 ppm of the chloramine TCCA (titrated as total Cl+) from pumped water to a concentration lower than the detection limit of iodometric/thiosulfate analytical titration (0.27 ppm) when the solution was circulated through the bead bed twice.

### Example 11

### Free Chlorine Concentrations from DPD Colorimetry

The USFDA regulatory standard for kidney dialysis water is <0.1 ppm free chlorine. Since the detection limit for free chlorine as Cl+ is only 0.27 ppm, experiments were performed using a Hach DR300 Pocket Colorimeter and the necessary reagents and instructions supplied by Hach, Inc. (Loveland, Colo., USA). In this procedure, packets containing the Hach free chlorine determination reagents were added to aliquots of 10.0 mL which produced a pink color, ranging from light to dark dependent upon the free chlorine concentration in the sample. Cuvettes containing the pink solution were then analyzed in the colorimeter set at a wavelength of 528 nm. Using a series of dilute standard solutions of known concentrations of free chlorine, the concentrations of free Cl+ in the samples exposed to PSH polymeric beads were determined.

In an experiment performed as in Example 5 above, 2.0 g of porous PSH polymeric beads and 150 mL of dilute sodium hypochlorite bleach with a Cl+ concentration of 2.6 ppm were stirred together in a 250 mL Erlenmeyer flask. The flask was sealed and kept in darkness to minimize any loss of chlorine not attributed to the PSH polymeric beads. At designated time intervals, 10.0 mL aliquots were removed in duplicate and subjected to analysis for residual free Cl+ using the DPD colorimetric method. The results shown in Table 7 represent averages of the duplicate sample analyses.

TABLE 7

| Time Interval (min) | Oxidative Cl Concentration (ppm) |
|---|---|
| 0 | 2.60 |
| 10 | 0.10 |
| 15 | 0.06 |
| 20 | 0.03 |
| 25 | 0.025 |
| 30 | 0.015 |

Without being bound by any theory, results in Table 7 clearly demonstrate that the PSH polymeric beads were able to reduce the concentration of Cl+ to the required regulatory standard for kidney dialysis water of 0.1 ppm within 10 minutes in this experiment.

Another set of experiments on pumped recirculated water were designed similarly to Examples 8-10 above. The two analytical methods for determining Cl+ concentrations were compared. For these experiments, the burette contained 1.0 g of PSH polymeric beads, a new sample being employed for the second replicate. The influx solution of dilute sodium hypochlorite contained 2.17 ppm of Cl+ as titrated by the iodometric/thiosulfate method and 2.60 ppm of Cl+ as determined by the DPD colorimetric method. At this concentration level, the iodometric/thiosulfate method was theorized to be more accurate. The results of the experiments of two replicates each having four cycles are shown in Tables 8 and 9 (data represent the average of two measurements; ND indicates no determination since the level of detection by the iodometric/thiosulfate method had already been reached).

TABLE 8
Experiment 1 Peristaltic Pump Recirculated Flow Free Chlorine Test

| | | Iodometric | DCD | | | Total |
|---|---|---|---|---|---|---|
| | | Titration | Colorimetry | Volume | Flow | Contact |
| | | Method | Method | Solution | Rate | Time |
| | | (Cl⁺ ppm) | (Cl⁺ ppm) | (mL) | (mL/sec) | (sec) |
| Cycle 1 | Influx | 2.17 | 2.60 | 125 | 0.75 | 2.68 |
| | Concentration | | | | | |
| | Effluent | 0.66 | 0.77 | | | |
| | Concentration | | | | | |
| Cycle 2 | Influx | 0.66 | 0.77 | 90 | 0.70 | 5.55 |
| | Concentration | | | | | |
| | Effluent | <0.27 | 0.30 | | | |
| | Concentration | | | | | |
| Cycle 3 | Influx | ND | 0.30 | 70 | 0.69 | 8.47 |
| | Concentration | | | | | |
| | Effluent | ND | 0.095 | | | |
| | Concentration | | | | | |
| Cycle 4 | Influx | ND | 0.095 | 50 | 0.60 | 11.77 |
| | Concentration | | | | | |
| | Effluent | ND | 0.035 | | | |
| | Concentration | | | | | |

TABLE 9
Experiment 2 Peristaltic Pump Recirculated Flow Free Chlorine Test

| | | Iodometric | DCD | | | Total |
|---|---|---|---|---|---|---|
| | | Titration | Colorimetry | Volume | Flow | Contact |
| | | Method | Method | Solution | Rate | Time |
| | | (Cl⁺ ppm) | (Cl⁺ ppm) | (mL) | (mL/sec) | (sec) |
| Cycle 1 | Influx | 2.17 | 2.60 | 125 | 0.77 | 2.59 |
| | Concentration | | | | | |
| | Effluent | 0.83 | 0.82 | | | |
| | Concentration | | | | | |
| Cycle 2 | Influx | 0.83 | 0.82 | 100 | 0.76 | 5.21 |
| | Concentration | | | | | |
| | Effluent | <0.27 | 0.33 | | | |
| | Concentration | | | | | |
| Cycle 3 | Influx | ND | 0.33 | 75 | 0.71 | 8.03 |
| | Concentration | | | | | |
| | Effluent | ND | 0.13 | | | |
| | Concentration | | | | | |
| Cycle 4 | Influx | ND | 0.13 | 50 | 0.63 | 11.22 |
| | Concentration | | | | | |
| | Effluent | ND | 0.0475 | | | |
| | Concentration | | | | | |

Without being bound by any theory, results in Tables 8 and 9 clearly demonstrate that the PSH polymeric beads were able to reduce the concentration of Cl to the required regulatory standard for kidney dialysis water of 0.1 ppm within about 10 seconds.

### Example 12

### Antimicrobial Testing

Chlorinated beads containing three different loadings of chlorine were prepared and packed into a glass burette column as described in other examples above. Demand-free water (50 mL phosphate-buffered to pH 7.0) containing Staphylococcus aureus (ATCC 6538) or Escherichia coli O157:H7 (ATCC 43895) were pumped through columns containing 3.0 to 4.0 g (empty bed volumes of 3.3 to 4.4 mL) of chlorinated beads. Identical control columns contained un-chlorinated PSH polymeric beads were treated in the same manner. Flow rates of about 3.0 mL/sec were employed. The effluents were quenched with 0.2 N sodium thiosulfate to stop any possible inactivation by shed free chlorine while plating.

Results demonstrated that fully chlorinated beads (ca. 20 weight percent Cl+) inactivated all of the bacteria in one pass through the column (6.9 log reduction of S. aureus in 1.1 seconds; 7.0 log reduction of E. coli in 1.1 seconds). The control column of un-halogenated PSH polymeric beads gave no reduction of either bacterium in a contact time of 1.6 seconds. This indicates that the bacteria were inactivated by the polymeric beads, not lost by filtration.

For partially halogenated PSH polymeric beads containing 10.5 weight percent Cl+, a 7.1 log reduction of S. aureus was obtained within 1.3 seconds of contact. For partially halogenated PSH polymeric beads containing 6.8 weight percent Cl+, a 7.2 log reduction of S. aureus was obtained within a contact interval of 1.5-3.0 seconds of contact. For fully brominated PSH polymeric beads containing 36.8 weight percent Br+, both bacteria were inactivated completely (7.0 log reduction) in less than 1.1 seconds of contact.

In analogous experiments for MPSH polymeric beads containing 6.3 weight percent Cl+, a 6.7 log reduction of both bacteria was obtained within a contact interval of 1.0-2.0 seconds of contact. The result for brominated MPSH polymeric beads (8.2 weight percent Br+) was less than 1.0 second of contact. Analogous experiments for NOM beads have not yet been performed.

Without being bound by any theory, results of the instant example illustrate that the polymeric beads of the present disclosure are antimicrobial in nature for water applications, requiring brief contact times even when the polymeric beads are not fully loaded with oxidative halogen.

Throughout this application, various publications are referenced. The disclosures of these publications in their entireties are hereby incorporated by reference in this application in order to more fully describe the compounds, compositions, and methods described herein. Various modifications and variations can be made to the compounds, compositions, and methods described herein. Other aspects of the compounds, compositions, and methods described herein will be apparent from consideration of the specification and practice of the compounds, compositions, and methods described herein. It is intended that the specification and examples be considered as exemplary.

1. A method of removing an oxidative compound from a liquid, said method comprising the step of contacting the liquid with one or more polymers, wherein the oxidative compound binds to the polymer and is removed from the liquid.

2. The method of claim 1, wherein the oxidative compound is selected from the group consisting of free chlorine, free bromine, a water-soluble chloramine, or any combination thereof.

3. The method of claim 1, wherein the polymer comprises PSH, wherein PSH is a repeating unit structure comprising 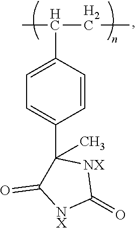
wherein X is independently H, Cl, or Br, or
wherein the polymer comprises MPSH, wherein MPSH is a repeating unit structure comprising 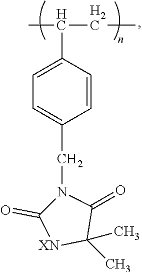
wherein X is independently H, Cl, or Br, or
wherein the polymer comprises NOM, wherein NOM is a repeating unit structure comprising 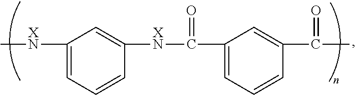
wherein X is independently H, Cl, or Br.

4. The method of claim 1, wherein the liquid comprises water.

5. The method of claim 1, wherein the liquid comprises water selected from the group consisting of water for kidney dialysis, water for potable water, water for bottled water, water for a water treatment pitcher, and water for an aquarium.

6. The method of claim 1, wherein the binding of the oxidative compound to the polymer is covalent binding.

7. The method of claim 1, wherein the method is configured for use in a vessel.

8. The method of claim 1, wherein the method is configured for use in a filter cartridge.

9. The method of claim 1, wherein the method is configured for use in a resin treatment bed.

10. The method of claim 1, wherein the method is configured for use in a water treatment unit comprising a reverse osmosis membrane.

11. The method of claim 1, wherein the method is configured for removing the oxidative compound from standing water, pumped water, or recirculated water.

12. The method of claim 1, wherein the polymer comprises particles.

13. The method of claim 1, wherein the polymer comprises beads.

14. The method of claim 1, wherein the polymer comprises porous beads.

15. The method of claim 1, wherein the polymer is cross-linked.

16. The method of claim 1, wherein the polymer comprises particles, and wherein the particles comprise beads.

17. The method of claim 16, wherein the polymeric beads are cross-linked.

18. The method of claim 1, wherein the polymer comprises particles, and wherein the particles comprise porous beads.

19. The method of claim 18, wherein the porous polymeric beads are cross-linked.

20. An antimicrobial composition comprising one or more polymers produced by the method of claim 1.

21. The antimicrobial composition of claim 20, wherein the antimicrobial composition comprises Cl, Br, or a combination thereof.
